(19) United States
(12) Patent Application Publication
(10) Pub. No.: US 2014/0285684 A1
(43) Pub. Date: Sep. 25, 2014

(54) DETECTING COUNTERFEIT PRINT MATERIAL WITH CAMERA-EQUIPPED COMPUTING DEVICE

(71) Applicant: QUALCOMM Incorporated, San Diego, CA (US)

(72) Inventors: William Y. Huang, Beijing (CN); Mingxi Fan, San Diego, CA (US); Xiaoyi Zhu, Beijing (CN); Ruowei Wang, Beijing (CN); Fan Ling, Shanghai (CN)

(21) Appl. No.: 14/351,523

(22) PCT Filed: Oct. 12, 2011
(86) PCT No.: PCT/CN2011/080674

§ 371 Date: Apr. 11, 2014

(51) Int. Cl. H04N 9/73

(52) U.S. Cl. CPC H04N 9/73
USPC 348/223.1

(57) ABSTRACT

An apparatus, system, and method for examining authenticity of printed material and distinguishing between original printed material and counterfeit printed material is disclosed. In one embodiment, the method is performed by a mobile device. The mobile device recognizes a reference point on a page of the printed material, computes a color balance ratio for that reference point, and compares the computed color balance ratio to an expected value for original printed material. Based on the comparison between the computed color balance ratio and the expected value, a determination is made as to the authenticity of the printed material. If the printed material is authentic, the mobile device may provide supplementary, complementary and/or additional information and content, for example, information related to the page or chapter of the printed material. If the printed material is not authentic, the mobile device may inhibit the presentation of additional material.

### CROSS-REFERENCE TO RELATED APPLICATIONS

This application is the National Stage of International Patent Application No. PCT/CN2011/080674, filed Oct. 12, 2011, which is incorporated herein by reference in its entirety.

### BACKGROUND

I. Field of the Invention

This disclosure relates generally to systems, apparatus and methods for detecting counterfeit print material, and more particularly to distinguish genuine printed material from counterfeit print material with a camera-equipped computing device, such as a smartphone or other mobile device.

II. Background

Publishers provide original printed material to consumers for education and entertainment. Publishers and others may provide additional content to users of the printed material. Often this printed and/or additional content is created at great expense.

In some scenarios, a counterfeiter may make unauthorized copies of a genuine copy of the printed material. Counterfeiters often reproduce original printed material, for example, using low-cost color scanners, color printers, and color copiers. In these situations, a consumer of the counterfeit printed material may access the additional content without having purchased the original printed material. In this case, the publisher does not reap the rewards of selling additional printed material and the additional content is used without consent or compensation.

Therefore, a method is needed to determine non-original unauthorized or counterfeit printed material from original printed material.

### BRIEF SUMMARY

Disclosed is an apparatus and method for examining authenticity of printed material. According to some aspects, disclosed is a method for examining authenticity of printed material, for example, to distinguish between original printed material and counterfeit printed material, the method comprising: capturing an image, with a camera of a mobile device, of at least a portion of a page of the printed material; determining a reference point in the image; computing a first color balance ratio at the reference point; and determining authenticity of the printed material based at least in part on the first color balance ratio. The method may be performed at a mobile device or at a server utilizing an image captured at a mobile device. Alternatively, the method may be performed using a combination of a mobile device and a server.

According to some aspects, disclosed is a mobile device for examining authenticity of printed material, for example, to distinguish between original printed material and counterfeit printed material, the mobile device comprising: a camera, wherein the camera captures an image of at least part of a page of the printed material; a processor and memory coupled to receive the image from the camera; a display coupled to the processor; wherein the processor enables determining a reference point in the image; computing a first color balance ratio at the reference point; and determining authenticity of the printed material based at least in part on the first color balance ratio.

According to some aspects, disclosed is a mobile device for examining authenticity of printed material, for example, to distinguish between original printed material and counterfeit printed material, the mobile device comprising: means for capturing an image of at least a portion of a page of the printed material; means for determining a reference point in the image; means for computing a first color balance ratio at the reference point; and means for determining authenticity of the printed material based at least in part on the first color balance ratio.

According to some aspects, disclosed is a device comprising a processor and a memory wherein the memory includes software instructions to examine authenticity of printed material, for example, to distinguish between original printed material and counterfeit printed material, the software instructions comprising code for: obtaining an image, captured with a camera of a mobile device, of at least a portion of a page of the printed material; determining a reference point in the image; computing a first color balance ratio at the reference point; and determining authenticity of the printed material based at least in part on the first color balance ratio. The instructions may be performed at a mobile device or at a server utilizing an image captured at a mobile device. Alternatively, the instructions may be performed using a combination of a mobile device and a server.

According to some aspects, disclosed is a computer-readable storage medium including program code stored thereon for examining authenticity of printed material, for example, to distinguish between original printed material and counterfeit printed material, the program code comprising code for: obtaining an image, captured with a camera of a mobile device, of at least a portion of a page of the printed material; determining a reference point in the image; computing a first color balance ratio at the reference point; and determining authenticity of the printed material based at least in part on the first color balance ratio. The code may be executed at a mobile device or at a server utilizing an image captured at a mobile device. Alternatively, the code may be executed using a combination of a mobile device and a server.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows a camera-equipped computing device taking an image of printed material.

FIG. 2 shows a block diagram of a mobile device 100, in accordance with embodiments of the present invention.

FIG. 3 shows creation of unauthorized copies from authorized reproductions.

FIGS. 4 and 5 illustrate a method to detect authenticity and to provide or inhibit additional content, in accordance with embodiments of the present invention.

FIG. 6 shows a captured image containing at least part of a page from the printed material, in accordance with embodiments of the present invention.

FIG. 7 illustrates a range of possible ratios, in accordance with embodiments of the present invention.

FIG. 8 shows a method in a mobile device for distinguishing original printed material from counterfeit printed material, in accordance with embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

As used herein, a camera-equipped computing device, may comprise and/or sometimes be referred to as a mobile device, a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device. Some mobile devices are capable of receiving wireless communication and/or navigation signals while other mobile devices may not have wireless access. The term “camera-equipped computing device” or “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “camera-equipped computing device” or “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “camera-equipped computing device” or “mobile device.”

The description below describes techniques for detecting when original and authorized print material has been reproduced, for example, by a lower quality color scanner/printer or by a lower quality color copier. A camera-enabled computing device, such as a smartphone or other mobile device, may use its camera and processor to distinguish authorized printed material from counterfeit printed material and to disable features (such as providing additional content) when it detects counterfeit printed material. Typically, counterfeit printed material incorporates color distortion from the low-cost printing process used by counterfeiters. This color distortion may be used to differentiate counterfeit copies from original printed material. Counterfeit printed material also may differ in ink intensity from the original printed material. Because of the wide variation of lighting conditions, however, an on-the-fly test involving luminance or intensity of ink may be inconclusive. A ratio of colors, on the other hand, is generally independent of intensity or luminance and therefore more useful in various room lighting conditions. Also, counterfeit printed material reproduced using a typical scanning/printing process may have difficulty matching fine or intricate printed patterns, which undergo degradation in the reproduction process. Embodiments described herein capitalize on these deficiencies to distinguish counterfeit printed material from original printed material.

Publishers of original printed material create hundreds, thousands or more copies of documents, such as books, pamphlets, brochures and posters, using expensive, high-quality printing presses and the like.

Publishers and others may provide additional content to users of the printed material. By way of example, the publisher may provide diagnostic tests, chapter quizzes, errata sheets, follow-on discussions, more in-depth information, background information, and other additional information. The additional information may be presented as text and graphics, audio files, video files, and even through augmented reality (AR) applications. For example, a consumer may direct a camera of a mobile device, such as a smartphone, to a particular page of the printed material. A mobile device may use computer vision (CV) recognition to find a particular target image on the page. Based on that particular target image, the mobile device may provide additional content for the consumer's consumption. A publisher may provide this additional content at no or little charge to the consumer since the publisher has already gained financially from the consumer's original purchase of the printed material.

Publishers tightly control scaling, orientation, line granularity, ink density, color intensity and color variations at the printing press. Using the naked eye, it may be difficult or impossible to detect differences between any two copies from the same printing press. The same control may not be exercised for pirated, counterfeit and unauthorized copies produced using lower-end color scanners, printers and copiers. During the counterfeit reproduction process, scaling, orientation, line granularity, color intensity and color balance is often ignored or in many circumstances cannot be tightly controlled. Thus, variations in color relationships and line granularity may be detectable, for example, by methods described herein. Therefore, embodiments of the current invention may distinguish artifacts found in counterfeit printed material but not original printed material or vice versa.

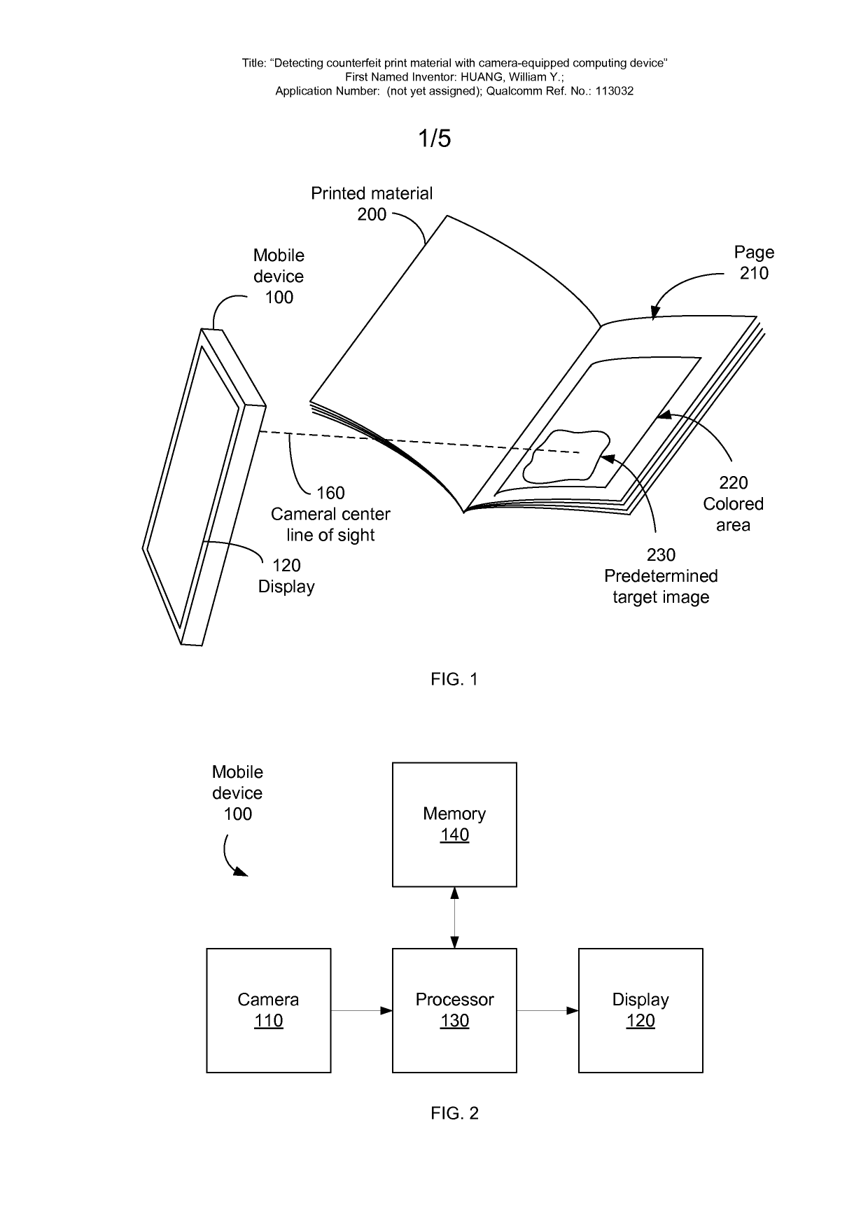

FIG. 1 shows a camera-equipped computing device taking an image of printed material 200. The camera-equipped computing device, also referred to as a mobile device 100, includes a camera 110 (not shown) and a display 120. The camera 110 captures images along a line of sight 160. The printed material 200, for example, a textbook, may include a page 210 having a colored area 220. The colored area 220 may be a color picture, color graphics, a color letter, a color icon, a colored icon or any other kind of color printing and may be printed in any number of sizes and/or shapes.

The colored area 220 may include a predetermined target image 230. The mobile device 100 finds the predetermined target image 230 on the page 210. The predetermined target image 230 may be a picture or graphics, for example: (1) of a man-made object, such as a chair or car; (2) of a natural object, such as a wing of the butterfly or mountain range; or (3) of a color logo or border. In some cases, an augmented reality (AR) application locates, identifies, and/or recognizes the predetermined target image 230, which may trigger the presentation of additional content. Unfortunately, present devices may provide the additional content without verifying the published material 200 is authentic. The additional content may therefore be viewed or utilized even when the printed material includes an unauthorized or illegal copy. Embodiments of the present invention determine if the published material 200 is authentic or not authentic before allowing additional content to be presented.

FIG. 2 shows a block diagram of a mobile device 100, in accordance with embodiments of the present invention. The mobile device 100 includes a camera 110, a display 120, a processor 130 and memory 140. The processor 130 may act as a means for executing the processes and methods described herein.

The processor 130 is coupled to receive a color image 170 from the camera 110. The image 170 may be in bit map (BMP) format, graphics interchange format (GIF), joint photographic expert group 2000 format (JPEG), tagged image file format (TIFF), YCbGr format, YUV format, or an equivalent digital color image format. The processor 130 may perform color balancing on the image 170. Color balancing reverses certain effects or distortions introduced by the camera 110 and its lens.

The processor 130 is also coupled to memory 140. The memory 140 may contain instructions, executable on the processor, for executing the processes and methods described herein. The memory 140 may also contain values indicating a valid color balance ratio range for various reference points in the colored area 220. Color balance ratios and ranges are described in greater detail below.

The processor 130 may also be coupled to a display 120 on the mobile device 100. Alternatively, or in addition to the display 120, the mobile device 100 may also contain a speaker. Additional content may be presented, via the display 120 and/or the speakers, based on the processor 130 determining the image 170 contains at least part of a page 210 from authorized printed material.

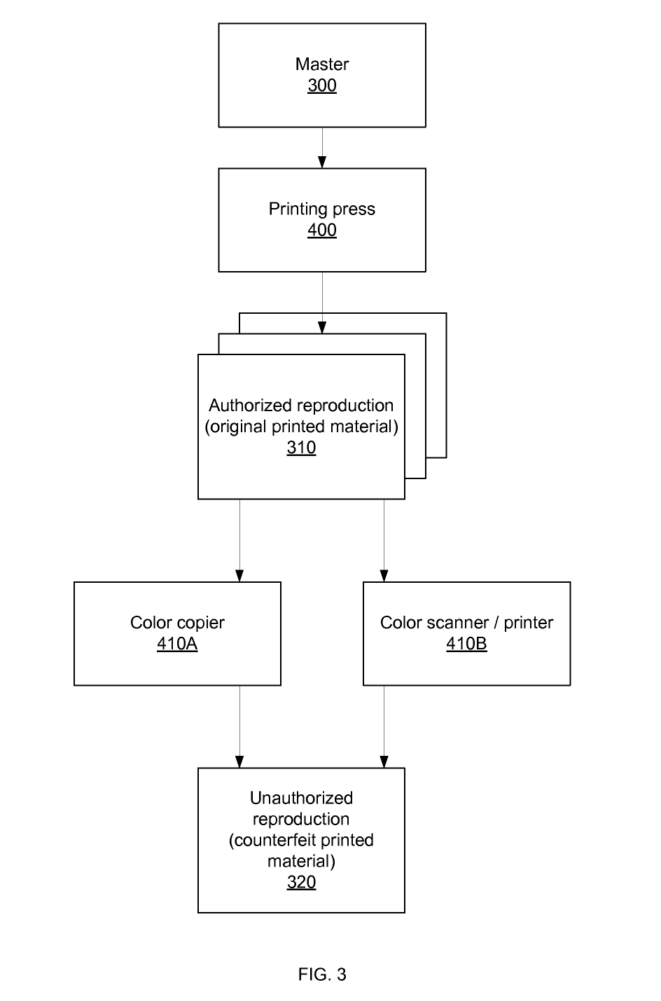

FIG. 3 shows creation of unauthorized copies from authorized reproductions. Printers and publishers often have one or multiple extremely high quality masters (such as master 300) that are used to create hundreds, thousands or more authorized reproductions (original printed material 310). In many circumstances, the master 300 is applied to a printing press 400 or a very high quality color copier. In this manner, the publisher creates and then distributes authorized reproductions (individually referred to as original printed material 310) to consumers and users desiring the printed material. At this point, a counterfeiter may obtain an authorized reproduction and attempt to duplicate the authorized reproduction (for example, using a color copier 410A and/or a color scanner and color printer 410B) to create one or more unauthorized reproductions (also referred to as counterfeit printed material 320). Often the counterfeit reproductions lack the higher quality found in the authorized reproduction, as discussed above.

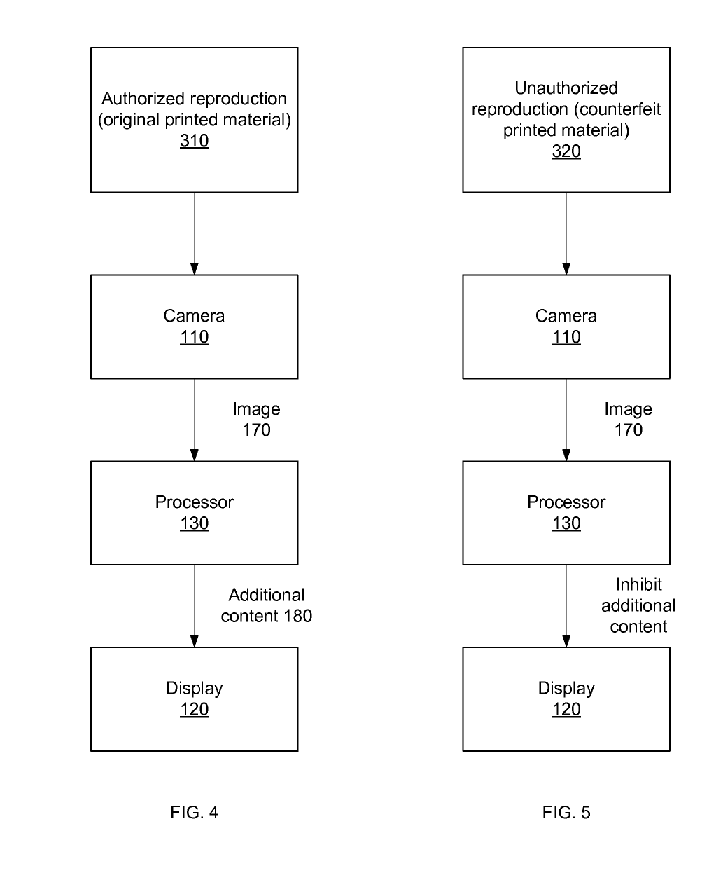

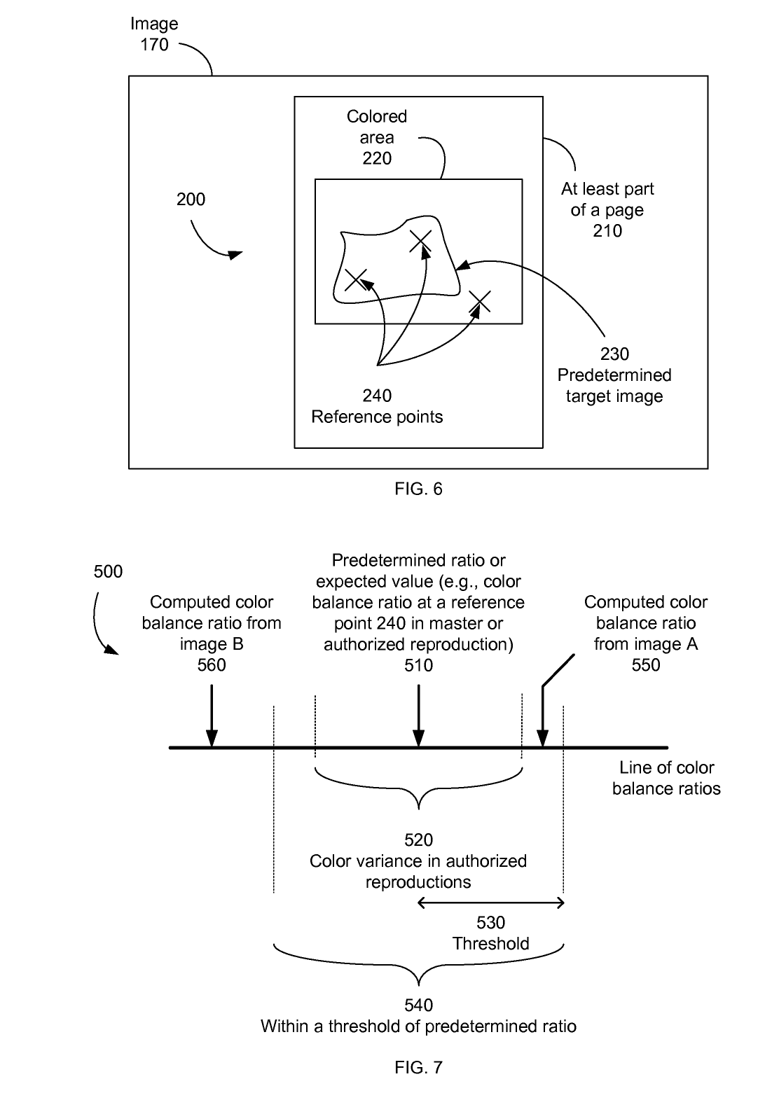

FIGS. 4 and 5 illustrate a method to detect authenticity and to provide or inhibit additional content, in accordance with embodiments of the present invention. In FIG. 4, end use of original printed material 310 is shown. A camera 110 on the mobile device 100 captures an image 170 containing at least part of a color page 210 of the original printed material 310. The color page 210 may contain a color picture, color drawing, color painting, color border, color logo or the like. A single pixel or grouping of pixels having color may be used for computing a color balance ratio. The processor 130 determines a particular pixel location in the image 170 (described below as a reference point 240 with respect to FIG. 6), determines two color components at this location in the image 170, and then computes a color balance ratio for this location. For example, the processor 130 may determine an amount of red and an amount of blue at one pixel location in the image 170. This location may be variable with respect to the image 170, for example, due to the angle of the line of sight 160 and/or the portion of the page 210 captured by the camera 110, but the location may be fixed with respect to the page 210, the colored area 220, and/or the target image 230.

The processor 130 then computes a ratio between these two amounts of color to find a color balance ratio. In this way, the processor 130 may calculate a ratio of a first color component or hue and a second color component or hue. If the color balance ratio is close to an expected value or a predetermined ratio, for example, within a predetermined threshold, the printed material is determined to be authentic. Alternatively, a color balance ratio may be computed for each of several separate reference points. In some embodiments, all ratios must be within a threshold of a respective expected value. In other embodiments, a majority of the ratios must be within a threshold of a respective expected value. In yet other embodiments, a predetermined number or percentage of ratios must be within a threshold of a respective expected value. The threshold may be similar for each reference point, or the threshold may vary from reference point to reference point. In some embodiments, a plurality of color ratios are computed for each reference point. For example, a red versus blue ratio, a red versus green ratio, and a blue versus green ratio (or any subset thereof) may be computed for each of a plurality of reference points. If the printed material is considered authentic, additional content 180 may be presented to a user of the mobile device 100.

In practice, the processor 130 receives this image 170 and may perform color balancing on the image to compensate for lens aberrations of the camera 110. The processor 130 then identifies one or more predetermined pixel locations (referred to as reference points) and computes one or more color balance ratios for each identified pixel location. For example, the processor 130 may identify a particular pixel or grouping of pixels in an image 170 based on the location on the page 210 of a reference point. The processor 130 determines how much of a first color is present (e.g., how much red) and determines how much of a second color is present (e.g., how much blue). These color values may be directly or indirectly extractable from the image 170 based on the image format. The processor 130 then computes a ratio between the colors thereby determining a color balance ratio for that particular pixel or grouping of pixels at the reference point.

In FIG. 5, a process using an unauthorized reproduction (counterfeit printed material 320) is shown. The process is identical to the process described with relation to FIG. 4, except the processor 130 computes a color balance ratio that is outside a valid range. Thus, the processor 130 determines the printed material 200 is not authorized and is counterfeit printed material 320. In this case, the processor 130 may inhibit or block additional content from being presented to the user of the mobile device 100.

FIG. 6 shows a captured image 170 containing at least part of a page 210 from the printed material 200, in accordance with embodiments of the present invention. Though the example page is shown as a top-down view, the perspective of the camera 110 of the printed material 200 is variable. The page 210 has a colored area 220, which may contain a predetermined target image 230. The colored area 220 may be a picture containing more than the target image 230 or may be just the target image 230 itself. The target image 230 may be a man-made object, a natural feature, a colored icon, a colored symbol, colored border or other colored feature. In some embodiments, the target image 230 is detected by computer vision (CV), such as by a computer vision image detection algorithm used in an augmented reality (AR) application or processor. Once the colored area 220 or the predetermined target image 230 is found, a reference point or set of reference points 240 may be identified. The reference points 240 are predetermined with respect to their placement within the colored area 220 or with respect to the target image 230 on the page 210. However, placement of the reference points 240 may not be predetermined with respect to their placement in the image 170 in some embodiments, for example, to allow for varied views or zoom levels that may be captured in the image 170. The placement of the reference points 240 may, however, be predetermined relative to other points within the image 170, for example, relative to the target image 230 when the target image 230 is also captured within the image 170. Each reference point 240 may be a single pixel or a set of neighboring pixels. The processor 130 detects color and computes a color balance ratio for each reference point 240. For example, if the processor 130 determines a reference point 240 contains 10 units of red and 20 units of green, the processor 130 may compute a color balance ratio of 10:20 or 0.5. If the computed color balance ratio is equal or close to a predetermined ratio or an expected color balance ratio (see expected value 510 in FIG. 7), the printed material 200 may be determined authentic and original printed material 310. When the printed material 200 is determined authentic, the display 120 or other element configured for interaction with the user may provide content associated with the page 210, the colored area 220, and/or the image 230. Alternatively, if the color balance ratio is not close to the expected value 510, the printed material 200 may be deemed unauthorized and counterfeit printed material 320.

FIG. 7 illustrates a range of possible ratios, in accordance with embodiments of the present invention. In the middle of possible ratios is an expected value 510. The expected value 510 may comprise a predetermined ratio that is an expected color balance ratio. The expected value 510 may be determined from a master 300 of the printed material 200 or from an authorized reproduction (original printed material 310). Some variation within a range 520 is expected when a color balance ratio is computed for multiple copies of original printed material 310, for example, due to variance in the printing and/or image capture process. However, the variation among counterfeit printed material 320 is expected to be greater. That is, when a particular color balance calculation falls within a threshold 530 from an expected value 510, the reference point 240 is considered to belong to an authorized copy (e.g., see placement of ratio 550 for image A). When a particular color balance calculation falls outside of a threshold 530 from the expected value 510, the reference point 240 is considered to belong to an unauthorized copy (e.g., see placement of ratio 560 for image B).

For unauthorized reproductions, a single reference point 240 may happen to fall within the threshold 530. However, if multiple separate reference points 240 are considered, some ratios may fall within and other ratios may fall outside a valid range; therefore, an unauthorized reproduction is more likely to be detected using ratio computations from multiple reference points 240. That is, if one ratio is computed for multiple separate reference points, a counterfeit is more likely to be detected. Similarly, if two color balance ratios are determined for a particular reference point 240, a higher degree of accuracy is obtained than checking just one ratio for the reference point 240. For example, a red versus blue color ratio may be detected for a reference point, and a blue versus green ratio may be determined for the same reference point.

With regard to expected values, each expected value 510 may be stored in memory 140. An expected value 510 may be in the form of a range 520 or may be in the form of a center value and a threshold 530. Each reference point 240 may have multiple expected values (e.g., one, two or three expected values 510). For example, a reference point 240 may have a first expected value representing a ratio of red to blue and a second expected value representing a ratio of red to green expected for an authorized reproduction. Similarly, the reference point may have a third expected value representing a ratio of blue to green.

An expected value 510 for a reference point 240 may be downloaded, by itself or with other expected values, in a file or an application (e.g., an application containing additional content) long before this authentication process is used to determine authenticity of printed material 200. Alternatively, an expected value 510 may be obtained dynamically as needed during the authentication process. For example, an expected value 510 may be obtained in response to an AR or CV application identifying or recognizing the colored area 220 and/or the image 230. An expected value 510 may be obtained wirelessly or by wire from a database on a remote server. In some embodiments, the same expected value 510 and/or threshold may always be used for a certain reference point in a particular colored area. For example, color balancing performed by the mobile device 100 may allow such expected value and/or threshold to be used. In other embodiments, an expected value and/or threshold of a reference point may vary, for example, depending on a type of camera or mobile device used to capture the image 170.

Ratio computations may be performed in the mobile device 100. Alternatively, an image 170 or pixel or color values found at a reference point 240 of the image 170 may be transmitted to a remote server so the remote server may determine authenticity of the printed material 200. In the case, a remote server may compute a color balance ratio and determine from that color balance ratio if the printed material 200 is genuine. For example, a mobile device 100 transmits an image 170 or part of an image 170 to a remote server then later receives from that remote server an indication of the validity of the printed material 200. The remote server may receive the image 170, find the reference points 240 in the image 170, compute the color balance ratio, then determine if the computed color balance ratio is within a threshold of an expected value.

Either theoretical or empirical methods may be used to determine the expected value 510. Using a theoretical method, a set of CMYK values or a PMS number may be converted to an expected value 510. CMYK refers to the four inks: (1) cyan; (2) magenta; (3) yellow; and (4) key black. The CMYK color model is a subtractive color model used in color printing and is also used to describe the printing process. PMS or Pantone Matching System is a proprietary color space also used in color printing. A publisher may provide a color as a set of CMYK values or a Pantone value for a reference point 240. This color may be used by the mobile device 100 or converted to a set of RGB values or to another color system used by the camera 110 or processor 130. The expected value 510 may be computed based on this converted color value.

Alternatively, the predetermined ratio 510 may be determined empirically. That is, a camera may be used to take one or more images of a reference point 240 of a particular page 210 of the master 300 or original printed material 310. A point within the image 170 may be selected as the reference point 240. A processor then may determine color values for that reference point 240 within the image of the master 300 or original printed material 310. Images may be taken from several samples to determine a variance. The variance may be used to determine the threshold 530.

Different values of 510 and 540 may be utilized for different types of hardware. In such embodiment, a table of 510/540 values corresponding to a type of device or camera used to capture the image 170 and/or to run an AR application to provide additional content may be used to determine an appropriate combination of the values 510 and 540. Such table or other information may be stored in the processor 130 and/or the memory 140, or may be stored remotely, for example, on a server in communication with the mobile device 100.

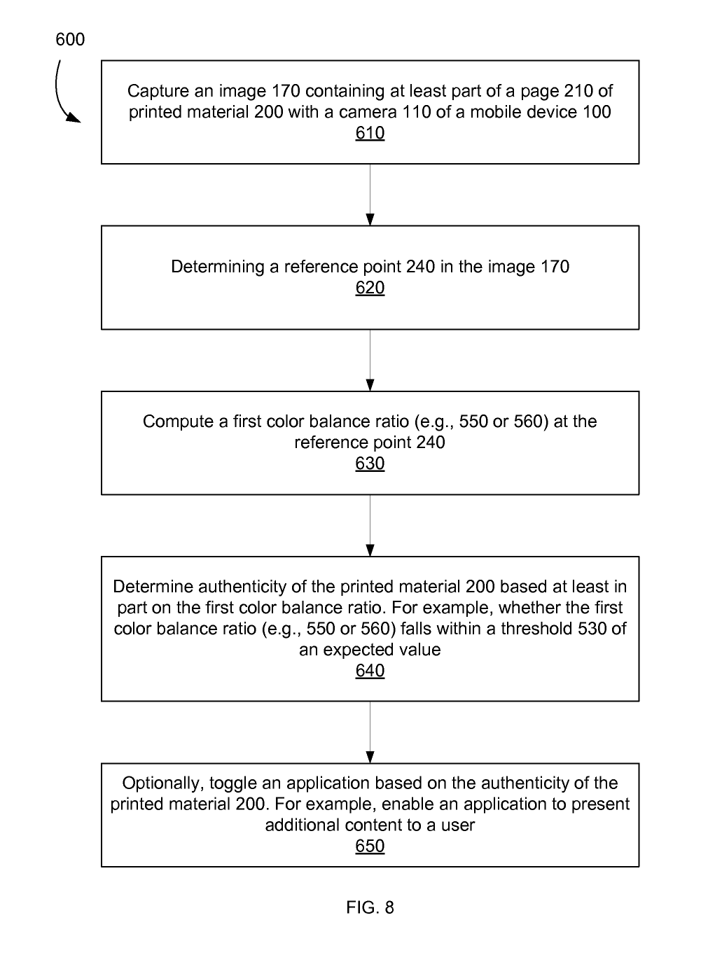

FIG. 8 shows a method in a mobile device 100 for distinguishing original printed material 310 from counterfeit printed material 320, in accordance with embodiments of the present invention. This method is generally referred to as 600.

At step 610, the mobile device 100 captures an image 170 containing at least part of a page 210 of printed material 200 with a camera 110 in the mobile device 100. The image 170 may optionally undergo color balancing in the camera 110 or processor 130 to reverse distortions from the camera 110 and its lens. This color balancing is separate from the computed color balance ratio described below. The camera 110 provides the image 170 to the processor 130.

At step 620, the processor 130 of the mobile device 100 detects one or more reference points 240 on the page 210 of the printed material 200. The mobile device 100 may optionally detect a predetermined target image 230 in the colored area 220 of the image 170 using, for example, computer vision recognition. The predetermined target image 230 may be an image of a man-made object, such as a picture or drawing of furniture, a building or a computer, or may be an image of a natural object, such as an animal, an insect, a face, a mountain range or a tree. Alternatively, the predetermined target image 230 may be a color border, a color character or any other color printed object. The reference points 240 may be within or part of the predetermined target image 230. The reference points 240 may also be at other locations within the colored area 220 but away from the predetermined target image 230. A predetermined target image 230 may be a handy reference when locating a reference point 240. In some embodiments, the target image 230 is recognized and/or detected using an AR process or algorithm. Such recognition or detection may be associated with additional content that the AR process or algorithm presents. Prior to presenting the additional content, however, the authenticity of the printed material 200 may be determined.

At step 630, the mobile device 100 computes a first color balancing ratio (e.g., 550 or 560 of FIG. 7) at the reference point 240 in the image 170. In some embodiments, the mobile device 100 computes a ratio between a first pair of colors (such as red and green, red and blue, or green and blue). Depending on how the colors are represented in image 170, other color schemes may be possible. In some embodiments, the mobile device 100 computes a single ratio between a first pair of colors, while in other embodiments, the mobile device 100 computes a first ratio between a first pair of colors and a second ratio between a second pair of colors for a reference point 240. In some embodiments, multiple reference points 240 are determined and one, two, three or more color balance ratios are computed for each reference point 240.

At step 640, the mobile device 100 determines the authenticity of the printed material based at least on the first color balance ratio. For example, based on whether the first color balance ratio is outside or inside of a threshold 530 from an expected value 510. The threshold 530 and expected value 510 may be represented as a range. The mobile device 100 compares the computed ratio to this valid ratio range. The valid range of ratios may be determined as a percentage from the expected value 510. Similarly, the valid range of ratios may be determined as a fixed constant or “distance” from the expected value 510. The threshold 530 may be set over inclusively to avoid false negatives or under inclusively to avoid false positives. Alternatively, the threshold may be set to a distance from the expected value 510 to the farthest observed ratio of an authorized reproduction.

In some embodiments, authenticity is determined based on a computed color balance ratio computed for several different reference points 240. In some embodiments, color balance ratios for the several reference points 240 must be considered authentic before the printed material 200 is deemed authentic. That is, any one color balance ratio falling outside the threshold 530 or range 520 for that reference points 240 leads to a conclusion that the printed material 200 is not authentic.

Optionally, at step 650, the mobile device 100 toggles an application based on the authenticity of the printed material 200. For example, if authentic, the mobile device 100 may enable an application, such as an application that presents AR content related to the page 210, colored area 220 or the predetermined target image 230 (e.g., a page 210 indicates the current chapter of the printed material 200). In some embodiments, a depiction of the image 170 or video being obtained from the camera 110 is rendered on the display 120, and the rendering is augmented with visual content. For example, additional information regarding the target image 230 or another aspect of the colored area 220 or page of the printed material may be visually associated with a respective portion of the target image 230 or other aspect of the colored area 220 or page of the printed material. In one example, a game is presented. In some embodiments, the AR content includes an interactive prompt for a user of the mobile device, for example, requesting that the user identify a certain object or aspect of the colored area 220 or page of the printed material. The user may do so by touching the display 120 or the printed material in some embodiments. In one example, the mobile device 100 may present a quiz or assessment to test whether the reader has comprehended the recent material. Such AR content may be used, for example, in conjunction with printed educational materials.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly or non-transitorily embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for examining authenticity of printed material, the method comprising:
capturing an image, with a camera of a mobile device, of at least a portion of a page of the printed material;
determining a reference point in the image;
computing a first color balance ratio at the reference point; and
determining authenticity of the printed material based at least in part on the first color balance ratio.

2. The method of claim 1, further comprising color balancing the image to compensate for aberrations of the camera.

3. The method of claim 1, wherein determining the reference point in the image comprises:
detecting a predetermined target image on the page using computer vision recognition; and
identifying the reference point with respect to the predetermined target image.

4. The method of claim 3, wherein detecting a predetermined target image comprises applying an augmented reality (AR) algorithm.

5. The method of claim 4, further comprising displaying at least a section of a captured image of at least part of the page on a display of the mobile device, wherein the AR algorithm augments the displayed image to include additional content associated with the target image when the printed material is determined to be authentic, and wherein the AR algorithm does not include the additional content when the printed material is determined to be inauthentic.

6. The method of claim 5, wherein the printed material comprises educational material, and wherein the additional content comprises a game, information about an object depicted in the target image, an interactive prompt, a test, a quiz, or an assessment.

7. The method of claim 1, wherein the page comprises a photograph or graphics of a man-made object, a natural object, a color character, a color border, or a color logo.

8. The method of claim 1, wherein the first color balance ratio comprises a ratio of red and green, a ratio of red and blue, or a ratio of green and blue.

9. The method of claim 1, further comprising toggling an application based on the authenticity of the printed material.

10. The method of claim 9, wherein toggling the application comprises enabling additional content for presentation to a user if the printed material is authentic.

11. The method of claim 1, further comprising:
computing a second color balance ratio at a point in the image;
wherein determining the authenticity of the printed material comprises determining the authenticity of the printed material based at least in part on the first color balance ratio and the second color balance ratio.

12. The method of claim 11, wherein the point at which the second color balance ratio is computed is the same as the reference point.

13. The method of claim 11, wherein the point at which the second color balance ratio is computed is separated from the reference point.

14. The method of claim 1, wherein determining authenticity of the printed material based at least in part on the first color balancing ratio comprises determining whether the first color balancing ratio is within a threshold of an expected value.

15. The method of claim 14, wherein the threshold is a percentage of a predetermined ratio or a predetermined deviation from the predetermined ratio.

16. The method of claim 14, wherein the threshold and expected value are represented by a range.

17. A mobile device for examining authenticity of printed material, the mobile device comprising:
a camera, wherein the camera is configured to capture an image of at least part of a page of the printed material; and
a processor coupled to receive the image from the camera;
wherein the processor is configured to enable
determining a reference point in the image;
computing a first color balance ratio at the reference point; and
determining authenticity of the printed material based at least in part on the first color balance ratio.

18. A mobile device for examining authenticity of printed material, the mobile device comprising:
means for capturing an image of at least a portion of a page of the printed material;
means for determining a reference point in the image;
means for computing a first color balance ratio at the reference point; and
means for determining authenticity of the printed material based at least in part on the first color balance ratio.

19. A device comprising a processor and a memory wherein the memory includes software instructions for a device to examine authenticity of printed material, the software instructions comprising code for:
obtaining an image, captured with a camera of a mobile device, of at least a portion of a page of the printed material;
determining a reference point in the image;
computing a first color balance ratio at the reference point; and
determining authenticity of the printed material based at least in part on the first color balance ratio.

20. A non-transitory computer-readable storage medium including program code stored thereon for examining authenticity of printed material, the program code comprising code for:
obtaining an image, captured with a camera of a mobile device, of at least a portion of a page of the printed material;
determining a reference point in the image;
computing a first color balance ratio at the reference point; and
determining authenticity of the printed material based at least in part on the first color balance ratio.
